(19) United States
(12) Patent Application Publication
(10) Pub. No.: US 2006/0266119 A1
(43) Pub. Date: Nov. 30, 2006

(54) Ultrasonic system for on-line monitoring of pressed materials

(75) Inventor: Wesley N. Cobb, Highlands Ranch, CO (US)

Correspondence Address: SWANSON & BRATSCHUN L.L.C., 1745 SHEA CENTER DRIVE, SUITE 330, HIGHLANDS RANCH, CO, 80129, US

(73) Assignee: Applied Sonics, Incorporated, Highlands Ranch, CO (US)

(21) Appl. No.: 11/439,018

(22) Filed: May 23, 2006

Related U.S. Application Data
(60) Provisional application No. 60/683,596, filed on May 23, 2005.

(51) Int. Cl. G01N 29/04; G01N 29/07

(52) U.S. Cl. 73/579; 73/597; 73/602; 100/99

(57) ABSTRACT

A method and apparatus for monitoring the quality of a material during die press manufacture. The material may be powder, a powder and binder mixture, a fluid or melted polymer or other material suitable for press manufacture. The method includes measuring a wave attribute of one or more ultrasonic waves transmitted through the material during or in certain instances before compaction. Information is derived from the measured wave attribute regarding a quality of the compaction of the material. The information regarding the quality of the compaction of the material may include but is not limited to, the density of the material, the uniformity of the material density, changes in the composition of the material, or the degree of consolidation of the material. The wave attribute measured may be but is not limited to, the time of flight of the ultrasonic waves traveling through one or more volumes of the material, the amplitude of the ultrasonic waves traveling through one or more volumes of material or the velocity of the ultrasonic waves traveling through one or more volumes of the material. An additional embodiment of the invention is an apparatus configured to perform the above method.

### RELATED APPLICATIONS

This application claims benefit of Provisional Application Ser. No. 60/683596 filed on May 23, 2005 entitled ULTRASONIC SYSTEM FOR ON-LINE INSPECTION OF PRESSED MATERIALS.

### TECHNICAL FIELD

The present invention relates to the ultrasonic inspection of materials pressed through a die. More specifically, the invention is a means of measuring the composition and quality in materials during press manufacture.

### BACKGROUND OF THE INVENTION

Compaction pressing of a material is a primary method of manufacturing products such as billets or pipes. The material is shaped by forcing it through a forming die. The materials are typically forced through the die using either a screw for continuous feed or a ram, after batches of the materials are loaded into the press. A central mandrel is often used to extrude materials having a hollow core. In addition, the rams of a compaction press can be contoured to produce a shaped billet. For each of these press manufacturing methods there is a need for measurement of the degree and quality of the compaction and the integrity of the final pressed item. In addition, it would be advantageous to monitor the pressed items on-line, while they are being compacted, so that quality issues can be addressed before a large number of defective items are produced.

Many different types of materials are suitable for press manufacture. Examples include dry powders that are mixed with binders and pressed into shapes. In addition, thermoplastic materials can be forced through dies in an extrusion press to form long billets that are later cut to size. As a further example, many ceramic materials are typically produced using a sequential process of mixing ceramic powder with an organic liquid binder (e.g., alcohols, ketones, polyethylene wax, and vinyl compounds) to form a moldable slurry. The slurry is then formed into a desired configuration by die pressing, and the “green compact” is then thermally treating to evaporate the binder. Kiln firing completes the manufacture. Density gradients in the “green” compacts after die pressing may cause distortions in the shape of the parts during kiln-firing, which necessitates expensive machining or grinding to obtain the final desired shape. Such non-uniform green density can also lead to cracks and/or shape distortion of the kiln-fired (sintered) ceramic product. Thus, it is important to monitor the uniformity of the density of the material, preferably during the die pressing operation.

Various apparatus and methods for on-line measurement utilizing ultrasound are known in the prior art. Continuous ultrasonic monitoring is used in the plastics industry, where the composition of polymer mixtures has been measured in real time. Non-intrusive ultrasonic sensors have been placed on the outside of steel pipes carrying polymer melts to an extruder. The solids concentration (degree of polymerization) of the polymer has been monitored continuously to give operators better control of the final product quality. This quality monitoring is described in the publication: W. N. Cobb, “Ultrasonic Measurement of Fluid Composition,” in Review of Progress in QNDE, Vol. 17, Ed. D. O. Thompson and D. E. Chimenti, Plenum (New York), 2177-2183, 1998. In addition, U.S. Pat. Nos. 5,630,982 and 4,740,146 describe an ultrasonic method for measuring the thickness of a plastic pipe after it exits the die of an extrusion press. Also, U.S. Pat. No. 5,951,163 describes an on-line technique for monitoring molten (metal) materials in a die using ultrasonic sensors. The sensors are shielded from the high temperature material by cooled buffer rods. The molten materials are inspected for inclusions, temperature changes and gaps in the filled mold.

Additional prior art relating to on-line monitoring of thermoplastic materials extruded through a die is described in U.S. Pat. No. 5,062,299. An ultrasonic transducer is placed at the exit orifice of an extruder to inspect for inhomogeneities such as voids and inclusions in semi-plastic materials like soap. A similar inspection approach for thermoplastic materials is described in W. N. Cobb and J. J. Johnson, “Ultrasonic Monitoring Of Materials During Extrusion Manufacture,” Proceedings of the IEEE Ultrasonic International Conference, Atlanta, Ga., October 2001. Here the ultrasonic sensors are embedded inside a sensor ring at the end of the die. Voids, cracks and inclusions are detected as the billet material exits the die and ring. The method couples the ultrasonic waves by making use of liquids that are exuded from the thermoplastic at high temperatures and pressures.

Unlike the above defect inspection systems for thermoplastic materials, few on-line ultrasonic systems for monitoring powder-pressed materials are known. As noted in U.S. Pat. No. 6,541,778, one of the problems of applying ultrasound to green ceramics is that ultrasound requires liquid coupling media, which often disintegrates green bodies.” This may explain why ultrasound has not been widely applied to the inspection of green ceramics or other powder-pressed materials after manufacture. To avoid the problem, air-coupled ultrasonic systems are under development for off-line, after-press inspection.

One system for on-line monitoring of pressed-powder billets (or pellets) is described in International Pat. No. EP/0347303. This invention uses acoustic emission sensors attached to the outside of a fixed, cylindrical die equipped with upper and lower rams. The acoustic emission sensors listen to the sounds emitted by the pellet as it is pressed. When sound is emitted that exceeds a threshold amplitude, an acoustic emission event is counted. If enough events occur, the events are interpreted as the appearance and propagation of crack defects in the pellet.

All the inspection systems described in the prior art provide only detection of cracks or voids in the pressed material. No information is provided on the degree of compaction or the consolidation of the material into a solid form. However, the degree of compaction or percent of “maximum theoretical density” achieved by the press operation is a critical quality parameter. In addition, there is no indication of the quality of the resulting compaction or the final integrity of the material once it is removed from the press. Existing on-line monitoring systems do not provide this information.

Voids and cracks will not be present in compaction-pressed materials because the high pressures would “close up” any volumes where the pressed particles are not tightly packed. Pressures in conventional die press manufacture often exceed 15,000 pounds per square inch and ram forces exceed several tons.

The present invention is directed toward overcoming one or more of the problems discussed above.

### BRIEF DESCRIPTION OF THE DRAWINGS

The present invention can be more readily understood in conjunction with the accompanying drawings, in which:

FIG. 1 is a drawing of a typical die and rams for a single-acting powder press for a cylindrical billet.

FIG. 2 is a diagram of the ultrasonic sensors and their location within the die and rams of a dual acting press.

FIG. 3 is a graph showing representative examples of ultrasonic signals from the invention for transmission operation through a cylindrical die.

FIG. 4 is a graph showing the ultrasonic wave amplitude and time-of-flight versus time during three compaction cycles of a pressed material.

FIG. 5 is a graph showing the ultrasonic wave amplitude plotted versus the time-of-flight measurement during three compaction cycles of a pressed material.

FIG. 6 is a diagram of an ultrasonic system for monitoring the compaction of materials extruded through a die.

### SUMMARY OF THE INVENTION

The need in the art is addressed by a method of monitoring the quality of a material during die press manufacture. The method includes measuring a wave attribute of one or more ultrasonic waves transmitted through the material during or in certain instances before compaction. From the measured wave attribute, information is derived regarding a quality of the compaction of the material.

Typically, the material is compacted by pressing with rams traveling inside of a die. Ultrasonic waves are sent through the compacted material using transducers located within or on the die or rams. The information regarding the quality of the compaction may consist of many types of information including but not limited to the density of the material and the uniformity of the material density. Alternatively, information regarding the quality of the compaction may consist of changes in the composition of the material. Alternatively, information regarding the quality of the compaction may consist of the degree of consolidation of the material.

The wave attribute measured to determine information regarding the quality of the compaction may be the time-of-flight of the ultrasonic waves traveling through one or more volumes of the material. Similarly, the wave attribute identified to determine information regarding the quality of the compaction can be the amplitude of the ultrasonic waves traveling through one or more volumes of the material. Similarly, the wave attribute measured or calculated to determine information regarding the quality of the compaction can be the velocity of the ultrasonic waves traveling through one or more volumes of the material.

The quality of the compaction may also be determined by comparison of the time-of-flight wave attribute for successive compactions of the material. Similarly, the quality of the compaction may be determined by comparison of the signal amplitude wave attributes for successive compactions of the material.

The quality of the compaction may also be determined from a wave attribute curve which is characteristic of the material under a known compaction. Similarly, the quality of a compaction may be determined by a comparison of a calculated or prepared wave attribute curve with a characteristic curve for a previous compaction.

An alternative embodiment of the invention is an apparatus for monitoring the quality of a material undergoing compaction during die press manufacture. The apparatus includes components, typically multiple ultrasonic transducers, for measuring a wave attribute of multiple ultrasonic waves transmitted along one or more paths through a material as described above. In one embodiment, the wave attribute is measured by at least one ultrasonic transducer embedded within a wall of a die which does not contact the pressed material. Typically, the ultrasonic waves are coupled from the die wall into the material by a binder component mixed with a powdered or polymeric material.

The wave attribute measured may be the amplitude of the multiple ultrasonic waves or the time-of-flight of the multiple ultrasonic waves. The apparatus may include components to measure or calculate wave velocity as well. In one embodiment, the apparatus also includes components to measure the ultrasonic wave attribute before compaction begins and subtract this attribute from measurements of the wave attribute after compaction begins. In addition, the apparatus may include other components for deriving a quality of the compaction of the material from the measurement of the wave attribute. Preferably, the derived quality of compaction is the uniformity of the material density. Alternatively, the derived quality of compaction may be changes in the composition of the material. Alternatively, the derived quality of compaction may be the degree of consolidation of the material. Preferably, the determination of the quality of the compaction of the material from the wave attribute proceeds according to the methods described above.

Unlike inspection after manufacture, the present invention provides monitoring of the materials while inside the die and there is no need for adding a liquid coupling agent. In addition, there is no need for a separate machine to do an inspection. The pressed billets do not need to cool sufficiently before handling by rollers or other equipment associated with a separate inspection machine. Using the present invention, the operators receive real-time information on the quality of the pressed products.

Detection of poorly compacted, inconsistent or unconsolidated materials using the invention would reduce the cost incurred by further processing rejected material. In some applications, the rejected material is reusable, saving the material cost. In addition, the manufacturing process is monitored for optimal performance and yield. Monitoring of the quality of materials at the manufacturing press is more reliable and less costly than provided by later, off-line testing of the finished billets.

### DETAILED DESCRIPTION OF THE INVENTION

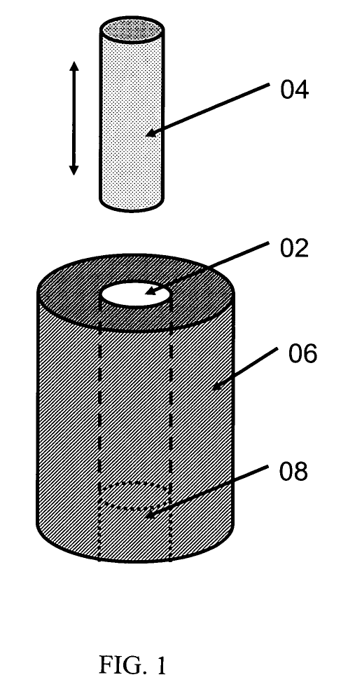

A typical die and ram for powder pressing is illustrated in FIG. 1. For this single acting press, the base and die are stationary and a ram is used to apply pressure to the material in the die from the top. External heaters on the outside of the die are used to maintain an elevated material temperature throughout the die. The pressed materials are typically in powdered form and are preloaded into the opening 2 at the top of the forming die. The material is compacted by exerting a strong downward force of several tons on the upper ram 4 while holding the die 6 and bottom plug 8 fixed to a stationary base. The press forcing cycle ends when the force is withdrawn. After one or more press cycles, the ram is extracted and the bottom plug removed. The cylindrical billets are removed by again forcing the ram through the die until the pressed billets exit at the bottom. Although a cylindrical die is depicted in FIG. 1, more complex dies are often used to create different shapes for the final pressed material. The design of the rams and die will be different for more complex shapes, but the process of containing and repeatedly compacting the powdered material is often the same as for cylindrical shapes.

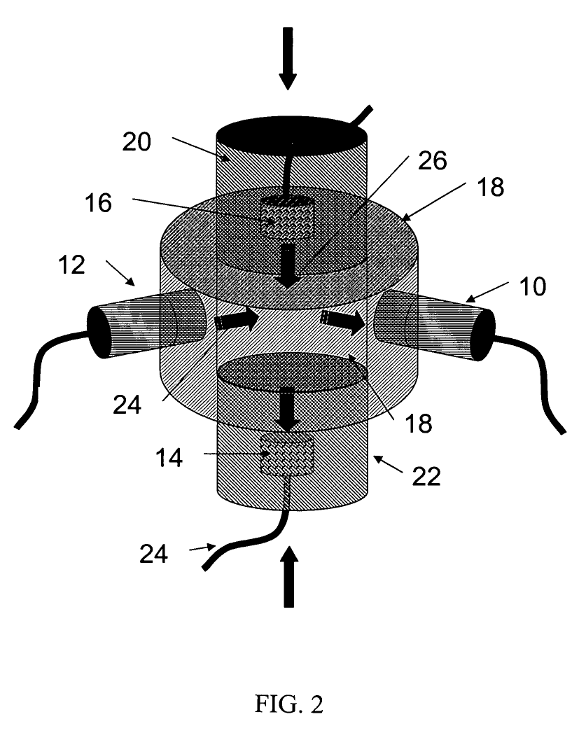

As illustrated in FIG. 2, a system of ultrasonic transducers is mounted on the die to measure and derive information regarding the quality of the compaction of the material and the physical characteristics of the pressed materials as they are compacted. These characteristics include but are not limited to the composition of the material, changes in the composition of the material, density, uniformity of density, the degree of material consolidation and the quality of compaction. Compaction or densification occurs simply by the motion of particle centers toward each other by mechanisms of particle rearrangement and deformation. Binders added to the particle or polymer mix fill in the spaces between particles as they move closer together. Consolidation refers herein to the process of forming inter-particle bonds in the compacted material. Although pressed to high density, a finished billet may separate, break-apart or chip near an edge if it is poorly consolidated. Multiple ultrasonic transducers may be used to provide wave paths through different areas of the pressed billet. In a preferred embodiment, transducers 10, 12, 14 and 16 are located in holes drilled part way into the rams and die of the press. Thus the transducers extend partially into the walls of the die 18 and rams 20 and 22, but do not contact the pressed material. Since the inner, shaping walls of the die 18 are not disturbed by these holes, the pressed billet is not affected in any way by the ultrasonic monitoring system.

Ultrasound is advantageous for press monitoring because the waves easily travel through the walls of the die and into the pressed material. The location of the sensors is selected to provide good signal transmission through the area of the billet under inspection. Ultrasonic waves 24 and 26 sent through the powdered and/or polymeric material being pressed are used to sense changes in the material composition, non-uniformity of density and other information regarding the quality of compaction as the billet is pressed.

Normally, ultrasonic waves will not travel from the solid material of the walls and into a loose powder or polymeric material which is not under compression. Since the sound waves will not travel through the air gap between the solid wall and the powder particles, some type of “coupling” liquid is required to conduct the waves. The loose powder does not conduct ultrasonic waves well because of the many air gaps between particles. Thus, when the loose particles are placed in the die without compaction force, no ultrasonic waves will be received by the transmission transducers. However, it has been discovered that under the strong compaction force and temperatures required for pressing powdered materials, the binder used to hold the final part together will flow between particles and coat the die walls. Under the high compaction pressure, this thin layer of liquid material serves as the required couplant, and strong ultrasonic signals can be transmitted through the pressed material. This ability of the binder to provide coupling allows the ultrasonic monitoring to be done without adding to or changing the formulation of the pressed material. Since all pressed powder products need some amount of binder to be present to hold the final part together, the ultrasonic monitoring will be possible for most powder pressed materials.

### EXAMPLE

The following example is provided for illustrative purposes only and is not intended to limit the scope of the invention.

### Example 1

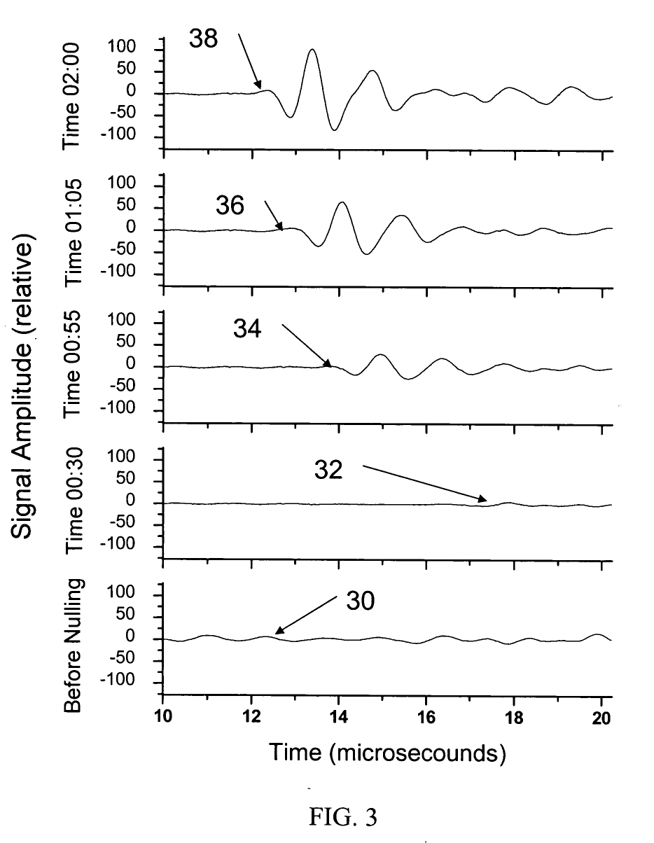

To illustrate the invention, FIGS. 3-5 show measurements of various ultrasonic wave attributes including the signal amplitude, time-of-flight (TOF) and ram force during press compaction of barium nitrate powder in a 12 ton press. Other wave attributes can be measured or calculated such as wave velocity. The press consisted of one-inch cylindrical die and rams configured as shown in FIG. 1. About 1 ounce of the powder was placed in the die before the top ram was inserted into the die. This press was equipped with a load-cell sensor to measure the axial ram force. The ultrasonic wave amplitude and time-of-flight changes during compaction were measured using two, one-megahertz, piezoelectric transducers placed in flat-bottomed holes directly across axis of the die as illustrated FIG. 2. These transducers were located at a height just above the fixed ram at the base of the die.

FIG. 3 shows example ultrasonic signals received through the die and powder at different stages of compaction. The received wave amplitude is plotted versus time for a time window from 10 to 20.24 microseconds after excitation of the transmitting transducer. The ultrasonic signals were recorded using a signal digitizer operating at 100 megahertz. The earliest signal 30, shown at the bottom of the series of plots, is the received signal before any compaction has occurred. For zero compaction, the powder will not support a wave and no received signal should be present. The signal in FIG. 3 is actually caused by wave energy that travels around the die opening, through the steel die walls, and is received by the transducer on the other side. The amplitude of these “short circuit” signals is significant and complicates the measurement of waves that pass through the compressed powder. This is especially true for powders that highly attenuate the ultrasound and result in only a small amplitude signal being received through the die.

To avoid the complication of the “short circuit” waves, the signal is recorded at a time just before the powder is compressed. This recorded signal is then subtracted from later digitized signals. In this way, signals are nulled (or zeroed) just before the compression begins. As the compression proceeds, some waves are conducted through the powder and result in signals that are easily distinguished from the low amplitude, nulled baseline. As an example of this early signal, FIG. 3 shows the recorded signal 32 at thirty seconds after the start of compression. The nulled signal amplitude is very small before the beginning rise of the through-transmitted signal, and the starting time of the wave can be easily determined (˜18 microseconds). This would not have been possible if the “short circuit” signal had not been removed.

The top three signals 34, 36, 38 in FIG. 3 show recorded signals for three successively later times after the start of compaction. As compaction increases, the signal amplitude increases because waves travel more easily through the binder-particle system and are better coupled to the die walls. In addition, there is a significant reduction in the TOF as the powder is compacted. Often, the TOF is converted into a sound velocity (V) for the material using the relation:
V=D/(TOF−D_{W}/V_{w}) [1]
where D is the distance across the pressed material. D_{W} and V_{W} are the distance traveled and sound velocity in the material separating the sensor from the pressed material (e.g. the exit die walls). The ultrasonic velocity is used to monitor changes in the elasticity and density of the pressed material. Note that the sound velocity V is related to the Young's modulus Y and density ρ of the material as:
V=\sqrt{Y/ρ} [2]

Since the transducer separation D in the die is fixed, Equation 1 implies an increase in ultrasonic velocity during compaction. Thus, if sound velocity is increasing during compaction, the Young's modulus must be increasing faster than the density is increasing. The invention provides information on both of these important material parameters.

In a preferred embodiment of the invention, the TOF and signal amplitude are recorded continually during the compaction of the powder. The open literature describes many different techniques for extracting amplitude and TOF information from signals. In this invention, the preferred means for measuring both parameters is to first compute the “envelope” of the received digitized signal. The peak amplitude is taken as the maximum value of the envelope in the signal time window. The TOF is determined by first applying a threshold to the envelop detected signal. The TOF is determined as the time when the envelope amplitude rises from the noise floor and exceeds the preset threshold amplitude. The threshold can be set to any value up to the maximum signal amplitude, but the preferred range is from 20 to 80 percent of the maximum amplitude. Since the peak signal amplitude changes during the press cycle, the threshold value also changes to provide a consistent TOF reading.

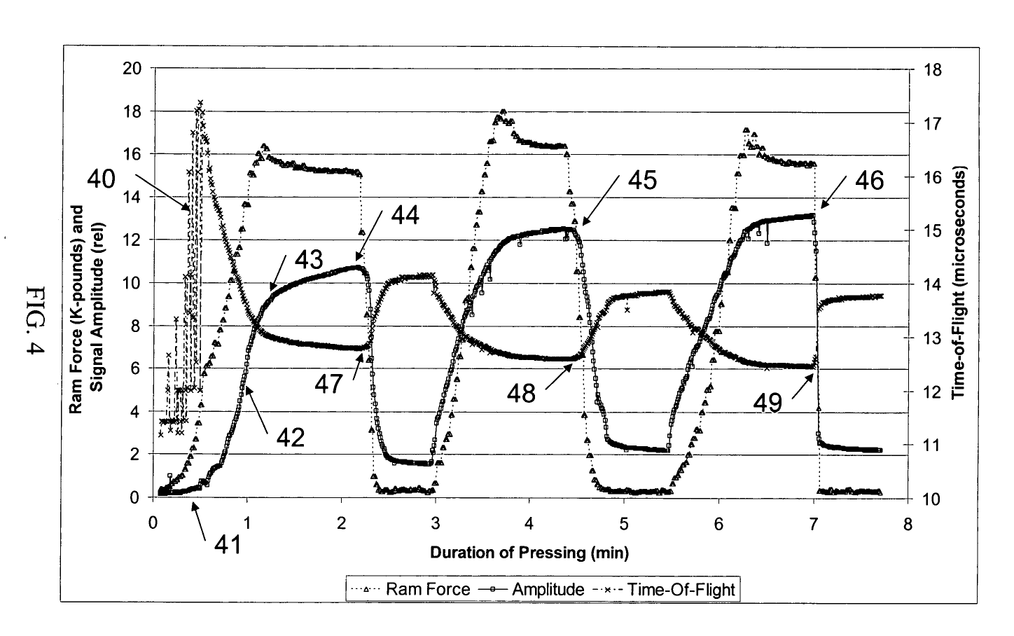

To illustrate the changes in the signal amplitude and TOF during compaction, FIG. 4 shows almost 500 rapid measurements of each parameter during three compression cycles performed over an eight minute period. For each cycle, the ram force increases rapidly to about 16,000 pounds as the ram moves down and compacts the powder. The ram is then held stationary for about one minute. During the stationary period, the ram force decreases slightly as the powder particles are further compressed. At the end of the stationary period, the force is slowly removed, and the ram is slightly lifted within the die. The ram force is kept at zero for about one minute and the cycle is repeated.

As shown in FIG. 4 the signal amplitude and time-of-flight measurements follow similar patterns for each press cycle. However, there are some differences between the first press cycle and later cycles. For the first cycle, as the ram force increases rapidly the signal amplitude increases more slowly. At the time when the ram force is approximately 6000 pounds, the signal amplitude 41 just begins to rise from zero. The signal at this point is shown as signal 32 in FIG. 3. At this point the powder is compacted just enough to support the propagation of an ultrasonic wave through the material. In addition, the binder is just now contacting the die walls sufficiently to couple waves from the pressed material into the metal die walls. Until this occurs, there is no thru-transmitted signal to measure, and the TOF readings are just noise 40. Once a sufficiently large signal is present, the TOF stabilizes at a high value (18 microseconds). This high TOF is characteristic of slightly compacted materials. As the ram force increases and compaction proceeds, the TOF decreases rapidly. Signals 34, 36 and 38 in FIG. 3 are measured at times 42, 43 and 44 in FIG. 4. Once the ram is held fixed, the TOF continues to decrease slowly as the force continues to compress the powder. Upon release of the ram force, the TOF quickly increases as the powdered material expands and density decreases. Once all ram force is removed at the end of a press cycle the TOF stabilizes at a fixed value. These values for each of the press cycles are marked 47, 48 and 49 in FIG. 4. Similarly, the signal amplitudes increase slightly during the fixed force period at the end of each press cycle. These amplitude values are marked 44, 45 and 46 in FIG. 4.

Analysis of the amplitude and TOF curves during the compaction cycles provides a wealth of information about the progress and quality of the pressing operation. At the end of each cycle the amplitude and TOF are characteristic of the degree or quality of compaction of the material at this stage of pressing. For example, the signal amplitudes 44, 45 and 46 increase at the end of each press cycle. This is due to the increased signal coupling of the ultrasonic waves to the walls of the die as well as reduced signal attenuation through the better compacted billet. Similarly, the TOF values 47, 48 and 49 are each slightly lower than the previous, indicating that the billet is more compacted (higher density) after each press cycle. Comparison of TOF values 48 and 49, however, show that the last of the three cycles resulted in only a slight increase in compaction relative to the first cycles. Thus, additional press cycles may not be beneficial to final billet quality. This information can be used to save the time and costs associated with further pressing of the billet.

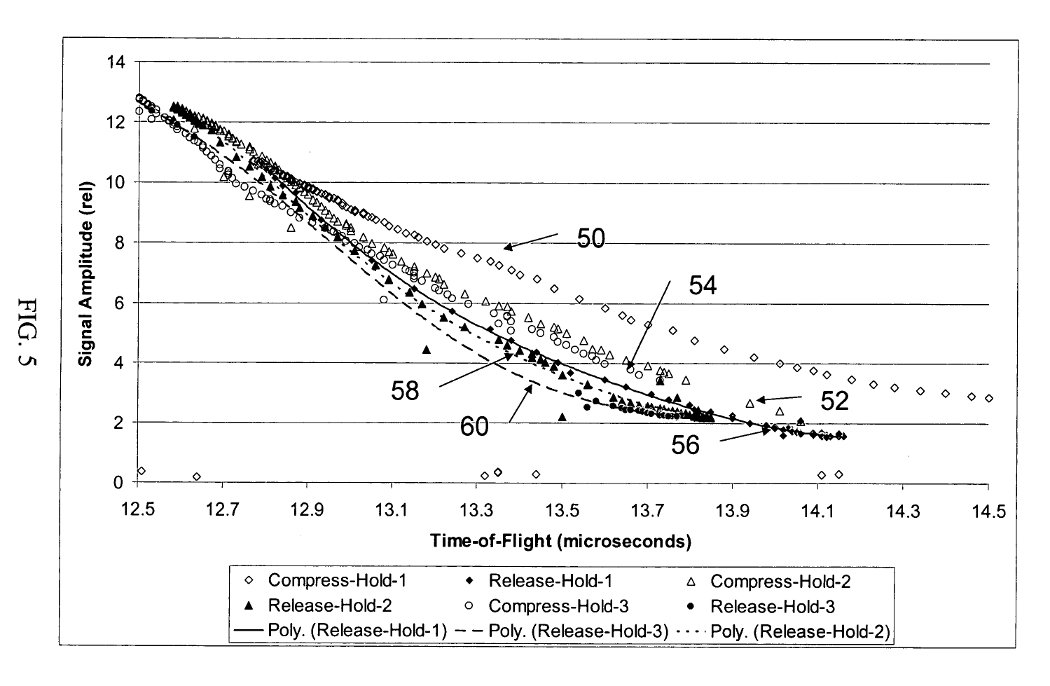

As an alternative to analyzing the ultrasonic parameter data versus compaction time, FIG. 5 shows the signal amplitude plotted versus the measured TOF for all three press cycles. The TOF values are plotted along the x-axis from 12.5 to 14.5 microseconds. Note that, to better visualize the data for later press cycles, the high TOF values near 18 microseconds at the beginning of the first press cycle have been omitted from the plot. The signal amplitude is plotted versus TOF for two distinct periods of each press cycle. The first period starts when the ram force is increased from zero and ends after the fixed ram force or “hold” period. Thus the end is at the same time when the TOF values 47, 48 and 49 of FIG. 4 are measured. The second period for each cycle begins when the ram force is released and ends after the ram force is held at zero (at the start of a new cycle). These periods are important because they are characteristic of the compaction process for each cycle. Each of these periods for the three cycles is marked differently in FIG. 5. Data for the “compress-hold” periods (50, 52 and 54) are marked with open symbols and the “release-hold” periods (56, 58, and 60) are marked with filled symbols of the same type. Six-order polynomials have been fitted to curves 56, 58, and 60 to better illustrate the shape of these ‘release-hold” curves.

Comparison of the curves in FIG. 5 shows signatures that can be used to quickly determine the quality of the compaction process. These characteristic curves are unique to the powder being pressed, and are independent of pressing rate and other compaction factors such as hold times. For example, curve 50 is for the initial compression and hold cycle at the beginning of the pressing. Note how the plot of amplitude versus TOF shows a smooth curve with a characteristic curvature. This curvature is indicative of how this particular powder compacts under the ram force during the first stage of compression. Comparison of this curve for different pressings of the same source material can be used for quality control. Significant differences could indicate a change in the formulation of the powder material or the introduction of a contaminant.

As another example of the utility of the characteristic curves, compare the separations of the compress-hold and release-hold curves for each successive cycle. Note that these curve pairs move towards lower TOF values for the same amplitude after each cycle. This movement is an indication of the increased compaction for each cycle. Any deviation from this characteristic movement will be an indication of quality problems. In addition, note that at the end of each cycle, curves 56, 58, and 60 move to lower amplitudes for a given TOF. Analysis of the amplitude differences at 13.5 microseconds gives a direct indication of the compaction progress for successive cycles.

FIGS. 3 through 5 illustrate example data for the compaction of one type of powder in one type of press. Signal amplitude and TOF curves will certainly be different for different materials, press/sensor configurations and compaction protocols. Indeed, the ability to measure these differences and relate them to quality factors is one of the primary benefits of the invention. To calibrate the invention, the TOF and amplitude parameters can be compared to previously measured values for pressed billets with different final densities.

Using high-speed, multiplexed transducers, this information can be simultaneously gathered for any number of wave paths through the billet. Thus, the quality of compaction can be quantified for many volumes within the billet during the actual compaction. Inconsistencies between the localized compaction values can then be used as a quality measure to accept or reject the final manufactured product.

In addition to the through-transmission operation, any of the sensors can be operated in pulse-echo mode. The waves emitted from one sensor reflect from poorly compacted areas in the pressed powders or polymer boundaries, and return to the same sensor. Backscattered signals and the pulse-echo mode can provide more sensitive monitoring of poor consolidation than is possible using through-transmission modes.

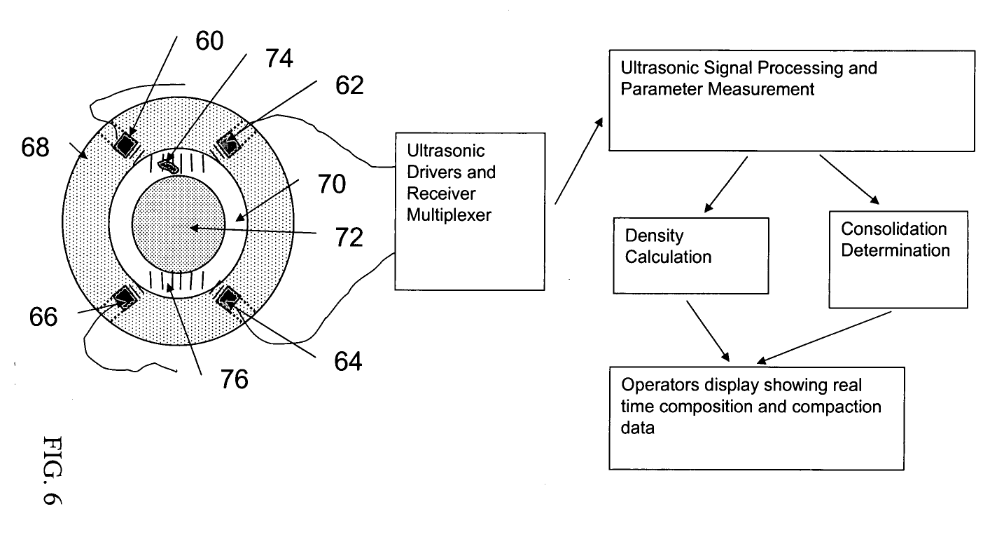

Although the above figures show data for continuous monitoring of a powder compacted press, the invention can be used in the same manner for an extrusion press. In this case, the transducers can be embedded in the same way into the die itself, or they can be located within a sensor ring near the exit of the die. FIG. 6 shows a cross section of transducers 60, 62, 64, 66 located within a sensor ring 68 at the end of an extrusion die. The ring is made of any material that allows for good transmission of the ultrasonic signal from the sensors into the thermoplastic polymer. The ultrasonic sensors are embedded within this ring, but are separated from the polymer melt by a small thickness of the ring material. The ultrasonic waves pass through this material and into the polymer as it is extruded. The hot polymer is in contact with the inner surface of this ring until it exits at the left side. At the temperatures and pressures of a common press, the polymer material is often in a molten or semi-liquid state. The liquid component of the mixture is used to couple the ultrasonic waves from the walls of the sensor ring or press die into the material. If any surface relief is required for proper sizing and separation of the billet 70, this is added to the inner surface of the ring. Another method of mounting the sensor is to make a die that incorporates the sensors within the body of the die. For either method, the ultrasonic waves must pass easily from the sensor ring, into the polymer and back to another sensor in another area of the sensor ring. In addition, the sensors are designed to operate continuously at the high temperatures common to extrusion machines.

The ring is made of a suitable material preferably with an acoustic impedance close to that of the extruded material. In this way, signal transmission into the thermoplastic extrusion will be improved compared to that for a metal die. Unlike the cylindrical die described above, the extrusion press may have a central mandrel 72 that would block waves traveling directly across the die. For this reason, the transducers are embedded around the ring at locations that allow the waves to travel mostly within the web of the billet 70 (see FIG. 6).

The ultrasonic sensor emits high frequency (e.g. 0.1-10 MHz) sound waves 74, 76 into the ring material. Because of the change in sonic velocity between the ring material and the polymer, the waves refract at the ring-polymer interface. For the through-transmission sensor pair shown in FIG. 6, the angle of the ultrasonic sensors is adjusted to give maximum signal amplitude at the receiver. This angle is found by determining the velocities in the materials and using “Snell's Law” to calculate the refraction path of the sound waves. Alternatively, it is found through experimentation with the actual materials. This is difficult, however, because the experiments must be carried out at the temperatures of the operating extruder.

As illustrated schematically in FIG. 6 and described above in detail, real-time measurements of the signal amplitude and TOF attributes are presented to the press operator in the form of parameter graphs or other output. As described above, these readings provide continuous on-line monitoring of the compaction density and consolidation for the pressed material. If the parameter should go out of preset ranges during extrusion, warning alarms may be set off. The operator then stops production or corrects the problem before waste material is produced. Thus, inspection at the press eliminates or drastically reduces the amount of final, off-line inspection needed.

The objects of the invention have been fully realized through the embodiments disclosed herein. Those skilled in the art will appreciate that the various aspects of the invention may be achieved through different embodiments without departing from the essential function of the invention. The particular embodiments are illustrative and not meant to limit the scope of the invention as set forth in the following claims.

What is claimed is:

1. A method of monitoring the quality of a material during die press manufacture, said method comprising:
(i) measuring a wave attribute of multiple ultrasonic waves transmitted through the material during compaction;
(ii) deriving from the measured wave attribute information regarding a quality of the compaction of the material.

2. The method of claim 1, wherein the measured wave attribute is a time-of-flight of the ultrasonic waves.

3. The method of claim 1, wherein the measured wave attribute is an amplitude of the ultrasonic waves.

4. The method of claim 1, wherein the measured wave attribute is the velocity of the ultrasonic waves.

5. The method of claim 1, wherein the quality of the compaction is derived by comparison of a time-of-flight wave attribute for successive compactions of the material.

6. The method of claim 1, wherein the quality of the compaction is derived by comparison of a signal amplitude wave attribute for successive compactions of the material.

7. The method of claim 1 wherein the information regarding the quality of the compaction of the material comprises information regarding at least one of:
a density of the material;
a uniformity of the material density;
a change in the composition of the material; and
a degree of consolidation of the material.

8. The method of claim 7, wherein the density of the material is derived by measuring a time-of-flight of ultrasonic waves traveling through at least one volume of the material.

9. The method of claim 7, wherein the uniformity of density is derived by measuring a time-of-flight of ultrasonic waves traveling through more than one volume of the material.

10. The method of claim 7, wherein the degree of consolidation of the material is derived by measuring an amplitude of ultrasonic waves traveling through one or more volumes of the material.

11. The method of claim 7, wherein the change in the composition of the material is derived by measuring the velocity of ultrasonic waves traveling through one or more volumes of the material.

12. The method of claim 1, wherein the quality of the compaction is derived from a wave attribute curve which is characteristic of the material under a known compaction.

13. The method of claim 12, wherein the wave attribute curve includes information concerning a time-of-flight of the ultrasonic waves and an amplitude of the ultrasonic waves.

14. The method of claim 12, wherein the quality of the compaction is derived by a comparison of the wave attribute curve with a characteristic curve for a previous compaction.

15. The method of claim 1 further comprising:
measuring an initial wave attribute before compaction begins; and
subtracting the initial wave attribute from a wave attribute measured after compaction begins.

16. An apparatus for monitoring the quality of a material undergoing compaction during die press manufacture, the apparatus comprising:
(i) means for measuring a wave attribute of multiple ultrasonic waves transmitted through a material; and
(ii) means for deriving a quality of the compaction of the material from the measurement of the wave attribute.

17. The apparatus of claim 16 wherein the derived quality of compaction is at least one of:
a material density;
a uniformity of the material density;
a change in the composition of the material; and
a degree of consolidation of the material.

18. The apparatus of claim 16, wherein the means for measuring a wave attribute comprises at least one ultrasonic transducer embedded within a wall of a die or ram which ultrasonic transducer does not contact the material.

19. The apparatus of claim 18, wherein ultrasonic waves are coupled from the die or ram wall into the material by a binder component mixed with a powdered material.

20. The apparatus of claim 16, wherein an ultrasonic wave attribute is measured before compaction begins and subtracted from an ultrasonic wave attribute measured after compaction begins.
